(19) United States
(12) Patent Application Publication
(10) Pub. No.: US 2011/0244776 A1
(43) Pub. Date: Oct. 6, 2011

(54) VENTILATION SYSTEM FOR A MOTOR VEHICLE, METHOD FOR CLIMATE CONTROL OF A MOTOR VEHICLE

(75) Inventor: Frank Jordan, Ruesselsheim (DE)

(73) Assignee: GM GLOBAL TECHNOLOGY OPERATIONS LLC, Detroit, MI (US)

(21) Appl. No.: 13/132,567

(22) PCT Filed: Nov. 30, 2009
(86) PCT No.: PCT/EP2009/008517

§ 371 Date: Jun. 2, 2011

(30) Foreign Application Priority Data
Dec. 3, 2008 (DE) 10 2008 059 886.0

(51) Int. Cl. B60H 1/00

(52) U.S. Cl. 454/69

(57) ABSTRACT

A ventilation system is provided for a passenger compartment of a motor vehicle having a fresh air supply, a heat exchanger for heating and/or cooling the supplied fresh air, a fan having settable power for generating a fresh air stream in the passenger compartment, a velocity sensor for establishing a current vehicle velocity, and/or a pressure sensor, a temperature specification device, and a control and/or regulating device for controlling and/or regulating the heat exchanger and the fan, the control and/or regulating device being implemented to reduce the power of the fan and to increase and/or reduce the quantity of heat discharged to or absorbed from the fresh air by the heat exchanger in the event of rising vehicle velocity and/or rising ram pressure.

### CROSS-REFERENCE TO RELATED APPLICATIONS

This application is a U.S. National-Stage entry under 35 U.S.C. §371 based on International Application No. PCT/EP2009/008517, filed Nov. 30, 2009 which was published under PCT Article 21(2) and which claims priority to German Application No. 102008059886.0, filed Dec. 3, 2008, which are all hereby incorporated in their entirety by reference.

### TECHNICAL FIELD

The invention relates to a ventilation system for a passenger compartment of a motor vehicle, which contains a plurality of components which interact with one another, inter alia, a fresh air supply, a heat exchanger, a fan, and a control or regulating device for controlling or regulating the components of the ventilation system which can be controlled or regulated.

### BACKGROUND

Ventilation systems are known in the prior art. In particular, it is known in the prior art that in motor vehicles at higher velocities, for example, above approximately 130 km/h, a ram pressure arises in the area of fresh air supplies for supplying fresh air for the passenger compartment, which has the result that more air enters the ventilation system than at lower velocities. This has the result that a higher volume stream of air reaches the vehicle interior. In heating operation, the vehicle therefore heats up additionally at high velocities, since more air flows past the heat exchanger of the ventilation system. In cooling operation, i.e., when the air conditioner is turned on, more cold air flows into the interior, which can result in noticeable and unpleasant cooling of the interior.

In order to counteract this effect, various approaches are known in the prior art. Thus, it is first generally known that a fan power is adapted as a function of the velocity, i.e., the fan power is throttled at higher velocities.

In addition, providing mechanical throttles in the fresh air supply is known in the prior art, which constrict the cross-section of the fresh air supply at higher velocities and thus keep the volume stream of supplied fresh air essentially consistent. Such systems are known, for example, from DE 103 49 429 A1 and from DE 44 14 036 A1, which show different designs of such a ram air throttle.

However, the above-described systems have the disadvantage that they may be the cause of noises in the air intake area at high velocities and the narrow ventilation cross-sections required for this purpose. In addition, such a solution requires an additional mechanical element which is in need of control, and which can be the cause of defects, on the one hand, and additionally increases the production costs.

In addition, a solution is known from DE 197 56 346 A1, which mechanically seals off an air intake opening against a relatively high ram pressure and simultaneously causes an air supply from an area in which a relatively lower pressure prevails during travel. However, this requires the provision of a plurality of air intake openings or one relatively large air intake opening, which allows the provision of such devices.

It is therefore desirable to improve a ventilation system of the type mentioned at the beginning in such a way that it manages without requiring further active or passive mechanical elements in the ventilation system, which control the air stream, and it allows a consistent climate control of the passenger compartment or the passenger interior independently of the velocity of the motor vehicle. In addition, other desirable features and characteristics will become apparent from the subsequent summary and detailed description, and the appended claims, taken in conjunction with the accompanying drawings and this background.

### SUMMARY

A ventilation system according to an embodiment of the invention for a passenger compartment of a motor vehicle has a fresh air supply, by which fresh air is introduced into the ventilation system from outside the vehicle. The fresh air supplied to the fresh air supply is supplied indirectly or directly to a heat exchanger, which is used to heat and/or cool the supplied fresh air. In motor vehicles without an air conditioner, the heat exchanger can only heat the fresh air, in the case of air conditioners, the air can be both heated and also cooled.

Furthermore, a fan is provided, which generates a fresh air stream into the passenger compartment of the motor vehicle, a power of the fan being settable, so that the fan operates at higher or lower power. In typical ventilators, the speed of the fan is a function of the supplied power, so that, for example, a lower fan speed is settable by voltage reduction and thus a lower volume stream of fresh air is generated.

The fan can be situated between fresh air supply and heat exchanger or between heat exchanger and passenger compartment or in a branch of the heat exchanger.

Furthermore, a velocity sensor is provided, which is used to establish a current vehicle velocity. A velocity sensor which is installed in any case in the motor vehicle can be provided as the velocity sensor. Alternatively to a velocity sensor, a pressure sensor can also be provided, which ascertains the currently applied ram pressure of the fresh air. Such a ram pressure sensor can preferably be situated in the area of the fresh air supply.

Furthermore, a temperature specification device is provided, using which a desired temperature in the passenger compartment is settable. The temperature specification device can be a nonspecific temperature specification device, using which only a heating and/or cooling power can be set, as were typical in the past, or a specific temperature specification device, which permits a desired interior temperature to be explicitly set.

Furthermore, a control and/or regulating device for controlling and/or regulating the interior climate of the motor vehicle is provided, which is implemented to control and/or regulate the heat exchanger and the fan. The control and/or regulating device can be implemented to control both components, to regulate both components, or to control one component and regulate the other component. The control and/or regulating device is connected to the velocity sensor and/or the pressure sensor in such a manner that sensor signals of the above-mentioned sensors can be supplied to the control and/or regulating device. Furthermore, the control and/or regulating device receives a temperature specification by the temperature specification device.

The control and/or regulating device is implemented for the purpose of reducing the power of the fan in the event of rising vehicle velocity and/or rising ram pressure, and increasing or reducing the quantity of heat output or absorbed by the heat exchanger, depending on whether or not an air conditioner is installed.

A higher ram pressure can first be compensated for by a reduction of the fan power, so that a consistent volume stream of heated or cooled fresh air is supplied to the vehicle interior. If the reduction of the fan power is insufficient to keep the interior climate consistent at high velocities, it is further possible with the aid of the invention to compensate for a necessarily higher volume stream of supplied fresh air in that the heating or cooling power is adapted.

If the ventilation system is in heating operation, the heating power of the heat exchanger is throttled and the fresh air is heated less strongly at high velocities than at low velocities. In this way, the heating power can be regulated in such a manner that the vehicle does not additionally heat up at high velocities.

In the reverse case, i.e., in cooling operation, the cooling power can be set via the power of the heat exchanger, for example, a vaporizer of an air conditioner, in such a way that the fresh air is not so strongly cooled at high velocities that the interior is cooled below the predefined temperature.

The control and/or regulating device can be a component of an onboard computer of the motor vehicle or a central vehicle control unit.

Control or regulation of the temperature of a passenger compartment can thus be achieved in a simple way without the provision of further mechanical components. An additional ram air throttle can therefore be dispensed with. The ventilation system according to the invention can be constructed using components installed in a vehicle in any case, in that velocity and/or pressure information is supplied to an adapted control and/or regulating device.

In particular, the ventilation system may be implemented in that the control and/or regulating device is programmed differently from known control and/or regulating devices, in that a velocity-dependent correction factor for the required heating and/or cooling power of the heat exchanger is implemented in an algorithm. Such a correction factor is essentially vehicle-dependent and may therefore be programmed at the factory.

Furthermore, it is possible to dispense with temperature regulation in the passenger compartment of the motor vehicle. The control and/or regulating device can ascertain a heating and/or cooling demand on the basis of the existing values and is not reliant on permanent feedback of an interior temperature.

Although only one heat exchanger is described, the heat exchanger can have multiple different components, for example, a heat exchanger which acquires its heat from an engine cooling circuit, an auxiliary heater, and/or a vaporizer of an air conditioner. In particular if at least two heat exchangers are provided, for example, a heat-discharging heat exchanger and a heat-absorbing vaporizer, the further advantage may be achieved that an ambient humidity of the supplied fresh air can be reduced with the aid of the vaporizer, so that fogging of the windows of the motor vehicle from the inside can be prevented and a pleasant air temperature can nonetheless be achieved by the heat-discharging heat exchanger.

An interior temperature sensor is nonetheless advantageously provided according to another embodiment, in order to ascertain a passenger compartment temperature. Plausibility checks can be performed with the aid of an interior temperature sensor, which ensure that a predefined temperature is maintained.

According to another embodiment, it is provided that the control and/or regulating device is implemented to detect a current passenger compartment temperature as a starting value, for example, employing an interior temperature sensor. This starting value can be used as a basis for calculating a required quantity of heat to be supplied or withdrawn as a function of the temperature specification.

Another embodiment of the invention provides that the ventilation system has an external temperature sensor, which is connected to the control and/or regulating device, and/or a fresh air temperature sensor, which is connected to the control and/or regulating device, and/or a timer.

With the aid of an external temperature sensor, an air temperature in the outside air can be established and a heating power, which must be supplied to the fresh air or removed therefrom, can thus be ascertained. The goal is that the fresh air supplied to the interior of approximately has a temperature which substantially corresponds to the preselected interior temperature, so that the feeling of a draft is avoided. The temperature of the fresh air is to deviate just strongly enough that cooling of the vehicle interior or heating thereof by the vehicle body is compensated for. The same effect may be achieved using a fresh air temperature sensor.

If a timer is provided, which is connected to the control and/or regulating device, more complex climate control programs may be implemented, for example, thawing of a front or rear windshield or strong cooling/heating for a specific temperature section when starting the vehicle or if another temperature specification is selected and the like.

A refinement of the ventilation system provides that the control and/or regulating device is implemented for the purpose of first reducing the power of the fan, preferably until the fan is completely turned off, in the event of rising vehicle velocity or rising ram pressure, and then, preferably when the fan is already turned off, increasing and/or reducing the quantity of heat discharged to the fresh air or absorbed from the fresh air by the heat exchanger. The temperature specification may be maintained more precisely by this sequential influencing of fan and heat exchanger, since the addition of two system errors can thus be prevented.

Another embodiment of the invention relates to a control and/or regulating device for a ventilation system of a motor vehicle according to one of the preceding claims. The control and/or regulating device is used to control and/or regulate a heat exchanger and a fan and is connected at least to a velocity sensor and/or a pressure sensor for ascertaining a ram pressure of the fresh air. Furthermore, the control and/or regulating device is implemented for the purpose of reducing the power of the fan in the event of rising vehicle velocity and increasing and/or reducing the quantity of heat discharged and/or absorbed by the heat exchanger to or from the fresh air, respectively.

According to another embodiment, further sensors can be provided, for example, an interior temperature sensor, an exterior temperature sensor, and/or a fresh air temperature sensor. A further component of the control and/or regulating device can be a timer.

According to another embodiment, the control and/or regulating device is implemented for the purpose, in the event of rising vehicle velocity, of sequentially first reducing the power of the fan and then, preferably when the fan is completely turned off or runs at a lower level, increasing and/or reducing the quantity of heat discharged and/or absorbed by the heat exchanger. The advantages achievable using the above-described ventilation system may thus be achieved.

A further embodiment relates to a motor vehicle having a ventilation system according to the above-described, which achieves particularly pleasant interior climate control.

Another embodiment relates to a method for controlling and/or regulating a ventilation system of a motor vehicle, in particular a ventilation system according to the above-described, in which a ram pressure and/or a vehicle velocity of the motor vehicle are measured and a power of a fan, which is used to generate a fresh air stream in a passenger compartment of the motor vehicle, is set and an increase or reduction of the quantity of heat discharged to or absorbed from the fresh air by a heat exchanger is performed as a function of a temperature specification and the ram pressure and/or the vehicle velocity. In this way, a consistent interior climate control can also be achieved in the event of high velocities without the necessity of an additional mechanical device which reduces ram pressure.

The method has the special advantage that it may be implemented in the form of an algorithm, for example, as a correction factor, which is a function of a vehicle velocity or a ram pressure.

In particular if the vehicle velocity is used to calculate the correction factor, sensors provided in every vehicle can be employed.

Another embodiment of the method provides that an interior temperature of the passenger compartment is recorded as a starting value. With the aid of such a starting temperature, a required quantity of heat, which must be supplied to or withdrawn from the interior until a preselected interior temperature is reached, can be calculated.

Another embodiment provides that the setting of the power of the fan and the increase and/or reduction of the quantity of heat discharged to or absorbed from the fresh air by the heat exchanger is performed as a function of a time since startup of the vehicle and/or the last detection of the interior temperature. More complex control programs which offer special comfort may thus be implemented.

Another embodiment provides that in the event of rising velocity or rising ram pressure, the power of the fan is first set or reduced to a minimum power, the minimum power possibly meaning a power having low air throughput or complete deactivation of the fan and then, when the power of the fan has been set to a minimum, the quantity of heat discharged to or absorbed from the fresh air by a heat exchanger is increased or reduced.

In heating operation, when the fresh air to be supplied is heated, the heat discharge of the heat exchanger is preferably reduced, or the heat withdrawal or cooling of the fresh air is reduced in cooling operation.

Further goals, features, and advantageous possible applications of the invention result from the following description of an exemplary embodiment on the basis of the drawings. All features which are described and/or shown in the figures form the subject matter of the present invention in the reasonable combination thereof, even independently of the claims and the references thereof.

### BRIEF DESCRIPTION OF THE DRAWINGS

The present invention will hereinafter be described in conjunction with the following drawing figures, wherein like numerals denote like elements, and:

FIG. 1 shows a motor vehicle having a ventilation system according to an embodiment of the invention; and

FIG. 2 shows a flowchart of the method according to an embodiment of the invention for controlling the ventilation system.

### DETAILED DESCRIPTION

The following detailed description is merely exemplary in nature and is not intended to limit application and uses. Furthermore, there is no intention to be bound by any theory presented in the preceding background or summary or the following detailed description.

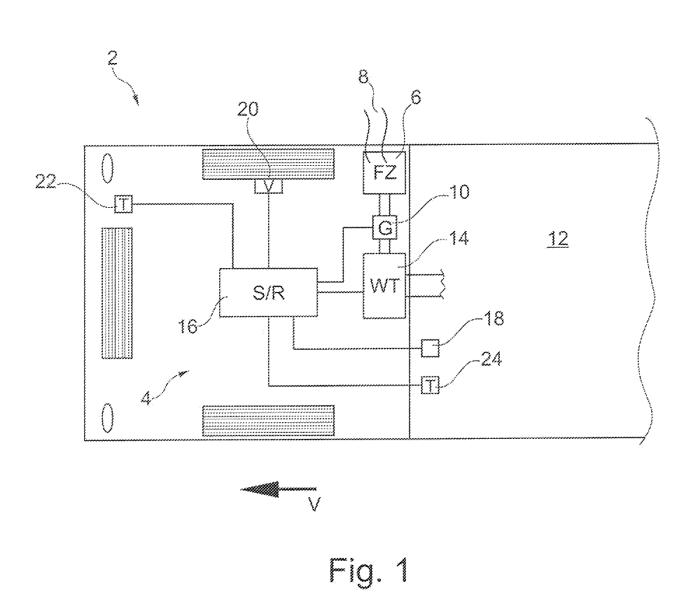

FIG. 1 shows a motor vehicle 2 having a ventilation system 4 according to an embodiment of the invention.

The ventilation system 4 has a fresh air supply 6, via which the fresh air 8 reaches the ventilation system 4. A settable fan 10 is used to generate a predefined volume stream of fresh air into an interior 12 of the motor vehicle, in which passengers are located. The fresh air 8 is heated or cooled as needed, or both simultaneously, for example, to dry the fresh air 8, with the aid of a heat exchanger 14. Subsequently, the heated or cooled fresh air 8 is conducted into the interior 12.

The heat exchanger 14 has a vaporizer of an air conditioner and a heat exchanger for discharging engine heat to the fresh air 8.

A control and/or regulating device 16 is used to control the fan 10 and the heat exchanger 14. For this purpose, the control and/or regulating device 16 receives a temperature specification via a temperature selection switch 18, which is typically situated in the interior 12 of the motor vehicle 2.

A velocity sensor 20, as is required for a speedometer of the motor vehicle 2 in any case, for example, and which detects the angular velocity of a wheel of the motor vehicle 2, for example, is also connected to the control and/or regulating device 16.

The control and/or regulating device 16 is further connected to an external temperature sensor 22 and an interior temperature sensor 24.

The control and/or regulating device 16 calculates a required fan power of the fan 10 using an algorithm and calculates a quantity of heat to be discharged or absorbed using the heat exchanger 14 using a velocity-dependent correction factor on the basis of the temperature, which is preselected by the temperature selection switch 18, and an interior temperature, which the control and/or regulating device 16 measures with the aid of the interior temperature sensor 24, the external temperature, and the velocity of the vehicle.

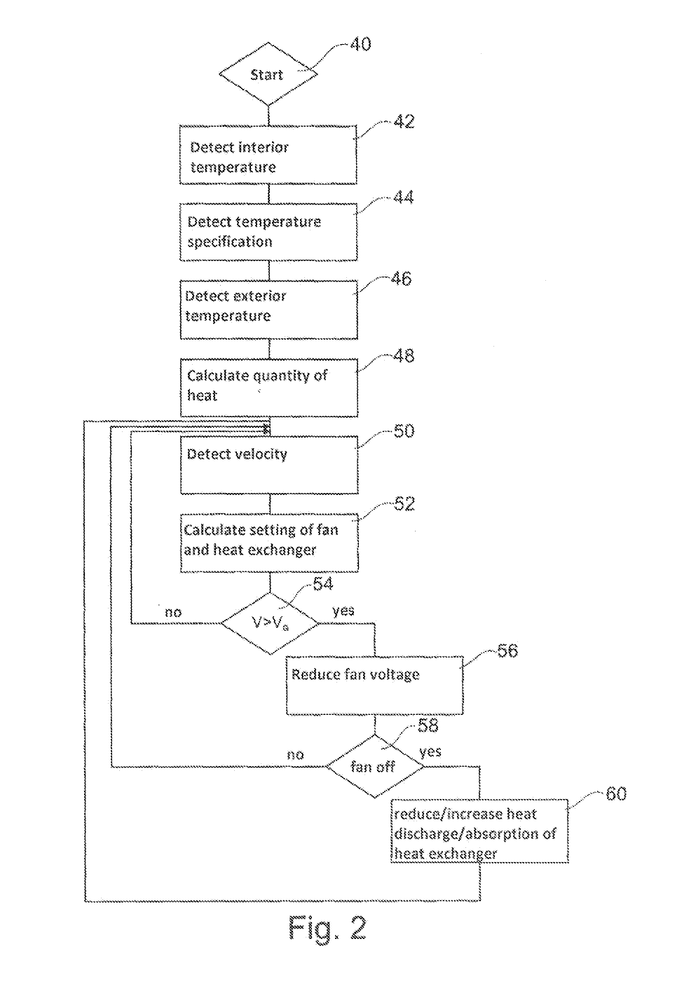

FIG. 2 shows a flowchart to illustrate the method according to an embodiment of the invention.

In a first step 40, the motor vehicle 2 is started. In a second step 42, the interior temperature is detected. In a step 44, a temperature specification using the temperature selection switch 18 is then detected, and an external temperature is detected in a step 46. A required quantity of heat to be supplied or dissipated is calculated with the aid thereof (step 48)

A velocity V of the vehicle is detected simultaneously and continuously in step 50. With the aid of the detected velocity, settings of the fan 10 and the heat exchanger 14 are calculated in step 52 and fan 10 and heat exchanger 14 are set correspondingly. If the velocity is greater than a limiting velocity, the fan voltage is reduced according to step 56.

If the velocity rises further, a further reduction of the fan voltage is performed until the fan 10 is completely turned off. The heat discharge or absorption of the heat exchanger 14 is then reduced or increased according to a correction factor.

The method is repeated continuously or at predefined intervals.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. A ventilation system for a passenger compartment of a motor vehicle:
a fresh air supply configured to provide fresh air;
a heat exchanger configured to condition the fresh air:
a fan comprising a settable power to generate a fresh air stream in the passenger compartment;
a velocity sensor configured to sense a vehicle velocity; and
a pressure sensor configured to sense a ramp pressure of the fresh air;
a temperature specification device configured to specify a desired temperature in the passenger compartment; and
a control device configured to control the heat exchanger and the fan, the control device further for configured to reduce power of the fan and to adjust a quantity of heat for the fresh air by the heat exchanger in an event of a rising of the vehicle velocity or a second rising of the ramp pressure.

2. The ventilation system according to claim 1, further comprising an interior temperature sensor configured to sense a passenger compartment temperature.

3. The ventilation system according to claim 2, wherein the control device is configured to detect the passenger compartment temperature as a starting value.

4. The ventilation system according to claim 1, further comprising:
an external temperature sensor connected to the control device; and
a fresh air temperature sensor connected to the control device; and
a timer.

5. The ventilation system according to claim 1, wherein the control wherein the control device is configured to:
increase the ramp pressure in the event of the rising of the vehicle velocity:
reducing the power of the fan until the fan is turned off;
adjusting the quantity of heat associated with the heat exchanger when the fan is turned off.

6. (canceled)

7. (canceled)

8. A method for controlling a ventilation system of a motor vehicle:
measuring a ram pressure and a vehicle velocity of the motor vehicle;
setting a power of a fan configured to generate fresh air in a passenger compartment of the motor vehicle; and
performing an adjustment of a quantity of heat discharged to or absorbed from the fresh air by a heat exchanger as a function of a temperature specification and the ram pressure and the vehicle velocity.

9. The method according to claim 8, further comprising recording an interior temperature of the passenger compartment as a starting value.

10. The method according to claim 8, wherein the setting of the power of the fan and the adjustment of the quantity of heat discharged to or absorbed from the fresh air by the heat exchanger is performed as a second function of a time since a startup of the motor vehicle.

11. The method according to claim 8, further comprising:
setting the power of the fan to a minimal power, in event of the rising of the vehicle velocity or a second event of the rising ram pressure; and
performing an increase or reduction of the quantity of heat discharged to or absorbed from the fresh air by the heat exchanger.
